(19) United States
(12) Patent Application Publication
(10) Pub. No.: US 2018/0193114 A1
(43) Pub. Date: Jul. 12, 2018

(54) DENTAL IMPLANT PROCEDURE BY SCANNING A CLOSED TRAY IMPRESSION

(71) Applicant: Optical Metrology Ltd., Jerusalem (IL)

(72) Inventors: Alexander ENTELIS, Maale Adumim (IL); Moshe GOLDSTEIN, Jerusalem (IL); Reuven SILVERMAN, Beit Shemesh (IL)

(21) Appl. No.: 15/740,030

(22) PCT Filed: Jun. 28, 2016
(86) PCT No.: PCT/IL2016/050689

§ 371 Date: Dec. 27, 2017

Related U.S. Application Data
(60) Provisional application No. 62/185,634, filed on Jun. 28, 2015.

(51) Int. Cl. A61C 8/00; A61C 9/00

(52) U.S. Cl. CPC A61C 8/0001; A61C 13/0004; A61C 9/0006; A61C 9/0053

(57) ABSTRACT

A method and device for generating an accurate model of the position of a dental implant in an intraoral cavity, by using a novel shape transfer cap for attachment to the dental implant, the shape transfer cap having a negative depression or a hollow in its end remote from the end by which it is attached to the implant. Such a negative depression forms a positive protrusion in the impression generated of the patient's intraoral cavity with the shape transfer cap. The impression is scanned in order to obtain the computer model for preparing the dental prosthesis for attachment to said implant, including the position and orientation of the implant within the intraoral cavity. The advantage of such a positive protrusion is that it can be more accurately scanned than a depression, which would be formed in the impression if a conventionally shaped transfer cap were used.

### BACKGROUND OF INVENTION

The construction of a dental superstructure with passive fitness, i.e. a superstructure without the need for positive screw attachments or the like, is one of the main objectives during implant-based prosthesis preparation. However, because of the high level of fit accuracy required, failure to achieve accurate passive fitness will incur stress on implants which can finally lead to fracture of the implant components and failure of the treatment. The forces created in the implant due to inaccuracies in the superstructure is even able to degrade the bone surrounding the implant and may cause ischemia within the peri-implant tissue, and prevention of subsequent healing. Non-mineral tissue may be formed around the implant, possibly resulting in mechanical damage to the bone, loosening of the implant components and fracture of the restoration. Impression techniques to obtain maximum accuracy of the implant position is thus of great importance. A degree of inaccuracy is present in the transfer of the implant positions by any impression methods. The most common techniques are the closed-tray or indirect impression procedure, and the open-tray or direct impression procedure, both of which are commonly used and cited in the literature. Not only spatial position but also angulation of the implants, i.e. the correct angular alignment of implants, play a key role in the accuracy of impression.

The closed tray technique has clinical advantages, since the impression-taking procedure is much easier for the dentist and patient, and the process takes significantly less time than the open tray procedure.

In this prior art procedure, the copings (or impression posts or implant abutments, or transfers as they are commonly known) are connected to the implants, and an impression is made and removed from the mouth, leaving the copings in the mouth. The copings are then removed from the mouth and re-inserted into the impression with an implant body analog attached thereto, and the impression is then sent to the laboratory for preparation of a working cast of the impression with the copings installed. The number of transfer steps here increases the likelihood of inaccuracies in the final dental superstructure made.

In U.S. Pat. No. 8,932,058 to R Fisker et al, for, “Impression Scanning for Manufacture of Dental Restorations” there is disclosed techniques for impression scanning for manufacturing of dental restorations for implant cases. However the proposed method is suitable for open tray techniques and not for closed tray techniques, because it requires a fixed transfer object which remains in the impression, and in the closed tray system, no transfer posts remain for attaching to the analog impression body.

There therefore exists a need for a scanning system and method which overcomes at least some of the disadvantages of prior art systems and methods.

The disclosures of each of the publications mentioned in this section and in other sections of the specification, are hereby incorporated by reference, each in its entirety.

### SUMMARY

The present disclosure describes new exemplary systems and methods for a closed tray solution to the problem of providing accurate scanned information for the production of dental superstructures. The advantage of the closed tray technique is that once the initial impression has been made in the mouth, a digital scanning technique is performed on the impression instead of using an additional analog casting of the impression, which increases the transfer inaccuracies. The only step which can degrade the accuracy of the procedure is therefore in producing that first impression.

The methods and systems of the present disclosure eliminate a need for casting gypsum model and allow accurate capture of the position and orientation of dental implants by direct scanning of the first impression, thereby minimizing the total error. The proposed method improves the accuracy of the closed tray impression, by replacing the re-insertion of the transfer posts and the implant body analogs, and the subsequent gypsum model casting, with a digital scanning step. In this manner, any inaccuracies generated by the reinsertion processes of the transfer posts and the implant body analogs, as in the prior art procedures, is avoided.

However, a problem with this method is that scanning of that part of an impression having negative features in it, i.e. indented or hollowed-out features, resulting from the impression made of a positive protruding feature attached to the implant, is difficult to perform accurately, because of the technical difficulties for the digital scanning system to accurately plot the inside of such a hollow feature.

In the presently described systems and methods, this difficulty is overcome by use of a novel scan body or more accurately, since it is not directly scanned, a novel shape transfer cap, for mounting on the dental implant in the patient's mouth for determination of the positioning and orientation of the dental implant, in which the shape transfer cap has a purposely generated depressed geometrical form in its outer end, being the end remote from the attachment end to the implant. This depressed geometrical form is generated independently of any mechanical requirements of the shape transfer cap. The digital scanning is performed on a closed tray impression generated of the patient's jaw taken with this shape transfer cap in place. The shape transfer cap differs from prior art scan bodies in that it expressly has the three-dimensional region having a depressed geometry at its outer end, so that when the impression is made, an oppositely matched positive geometrical form is created. Such a positive form can be much more accurately scanned than its corresponding negative match, such that the digital scan of the impression has higher accuracy levels.

The scan result of this impression of the shape transfer cap may be compared to the known three dimensional scan data obtained from the manufacturer of the scan body, or from an electronic scan data storage library, this scan body being the negative of the shape transfer cap. This comparison allows the exact determination of the position and the alignment of the dental implant in the intraoral cavity.

As with prior art scan bodies, the present shape transfer cap has a transition region axially between the scan region and the interface, and a fastening screw for fixing the scan body into the implant. The shape transfer cap can be engaging (i.e. defining the rotational orientation relative to the dental insert) or non-engaging (i.e. without any rotational information).

In this disclosure, a shape transfer cap is intended to mean any element which enables the definition in space of the position and angle of an implant, and is used in order to enable that spatial and angular information to be transferred to a digitally scanned model of the intraoral cavity, by generating an impression of the cavity including the shape transfer cap located in place on its implant, that impression then being scanned.

Furthermore, reference to negative features or depressed features are intended to include any indented or hollowed-out features, which appear as protruding features in an impression made thereof.

There is therefore provided in accordance with a first exemplary implementation of this disclosure, a method for generating a model of the position of at least one dental implant in an intraoral cavity, comprising:

(i) attaching a shape transfer cap to the at least one dental implant,
(ii) forming an impression of a section of the intraoral cavity including the shape transfer cap,
(iii) generating a scan of the impression of a section of the intraoral cavity, and
(iv) analyzing the optical scan such that the model of the position of the at least one dental implant is defined in the intraoral cavity,
wherein the shape transfer cap has a negative depression provided in its end remote from the end of its attachment to the at least one implant, the negative depression having been purposely provided in order that the scan of the impression of the shape transfer cap is performed on a corresponding protruding feature.

In such a method, the scan may be a three dimensional optical scan, in which case, the three dimensional optical scan may be any of a conoscopic holography scan, triangulation measurements, a patterned light scan measurement and a confocal imaging method. Additionally, in any of the above mentioned methods, the step of analyzing may comprise comparing the scan of the impression of the shape transfer cap with the known scan coordinates of the shape transfer cap, such that at least one of the position and orientation of the implant in the intraoral cavity can be determined from that comparison.

A further exemplary implementation of the present disclosure may be a system for generating a model of the position of at least one dental implant in an intraoral cavity, the system comprising:

(i) a shape transfer cap adapted to be attached to the at least one dental implant, the shape transfer cap having known scan coordinates, and
(ii) an impression tray configured for making an impression of a section of the intraoral cavity including the shape transfer cap,
wherein the shape transfer cap may have a negative depression formed in its end remote from the end for attachment to the at least one implant, the negative depression having been purposely formed such that an impression of the shape transfer cap has a corresponding protruding feature. The system may further comprise an attachment screw for locking the shape transfer cap to the dental implant.

Any of the above described systems, may further comprise a control system incorporating a comparison routine, adapted to enable comparison of a scan of the impression of the shape transfer cap with the known scan coordinates of the shape transfer cap, such that at least one of the position and orientation of the implant in the intraoral cavity can be determined from the control system. In such a system, the scan may be a three dimensional optical scan, in which case, the three dimensional optical scan may be any of a conoscopic holography scan, triangulation measurements, a patterned light scan measurement and a confocal imaging method.

Yet other implementations perform a method for generating a model of the position of at least one dental implant analog in a model of an intraoral cavity, comprising:

(i) attaching a shape transfer cap to the at least one dental implant analog,
(ii) forming an impression of a section of the model of the intraoral cavity including the shape transfer cap,
(iii) generating a scan of the impression of a section of the model of the intraoral cavity, and
(iv) analyzing the optical scan such that the model of the position of the at least one dental implant analog is defined in the model of the intraoral cavity,
wherein. the shape transfer cap has a negative depression purposely formed in its end remote from the end of its attachment to the at least one dental implant analog, such that the scan of the impression of the shape transfer cap is performed on a corresponding protruding feature. In such a method, the scan may be a three dimensional optical scan.

In some implementations of the latter methods, the analyzing step may comprise comparing the scan of the impression of the shape transfer cap with the known scan coordinates of the shape transfer cap, such that at least one of the position and orientation of the dental implant analog in the model of the intraoral cavity can be determined from the comparison.

### BRIEF DESCRIPTION OF THE DRAWINGS

The present invention will be understood and appreciated more fully from the following detailed description, taken in conjunction with the drawings in which:

FIG. 1 shows an isometric view of a non-engaging shape transfer cap of the type described hi the present disclosure;

FIG. 2 shows a cross sectional drawing of the shape transfer cap of FIG. 1;

FIG. 3 shows an example of a patient's mouth with multiple shape transfer caps fitted;

FIG. 4 shows a closed tray impression;

FIG. 5 shows the impression with the positive shape created from the depressed geometry of the shape transfer cap of FIG. 1;

FIG. 6 shows a visual presentation of the digital output of scanning the impression shown in FIG. 5 with its shape transfer caps;

FIG. 7 is an isometric view of the top of an engaging shape transfer cap of present disclosure;

FIG. 8 is a bottom isometric view of the shape transfer cap of FIG. 7;

FIG. 9 shows front and side views of the shape transfer cap of FIGS. 7-8;

FIG. 10 is a top view of the shape transfer cap of FIGS. 7-9, showing an engaging feature and a hole 105 for the locking screw;

FIG. 11 is a exploded view of the shape transfer cap mounted on the implant with its locking screw;

FIG. 12 shows a representation of the shape transfer cap of FIGS. 7-11 mounted on an implant inside the patient's mouth between two teeth;

FIG. 13 shows a schematic sectional view of the mouth of the patient of FIG. 12, showing the shape transfer cap mounted on the implant by means of the locking screw;

FIG. 14 shows schematically a closed tray impression taken on the section of the mouth shown in FIGS. 12 and 13, showing the impression material defining in negative the patient's teeth and the shape transfer cap;

FIG. 15 shows a detailed cross-sectional view of the shape transfer cap during the impression taking procedure, showing the impression material and the shape transfer cap mounted on the implant by means of the locking screw 107; and

FIG. 16 shows a detailed cross-sectional view of the impression after extracting from the patient's mouth, showing the impression material with the positive feature generated from the negative feature of the shape transfer cap.

### DETAILED DESCRIPTION

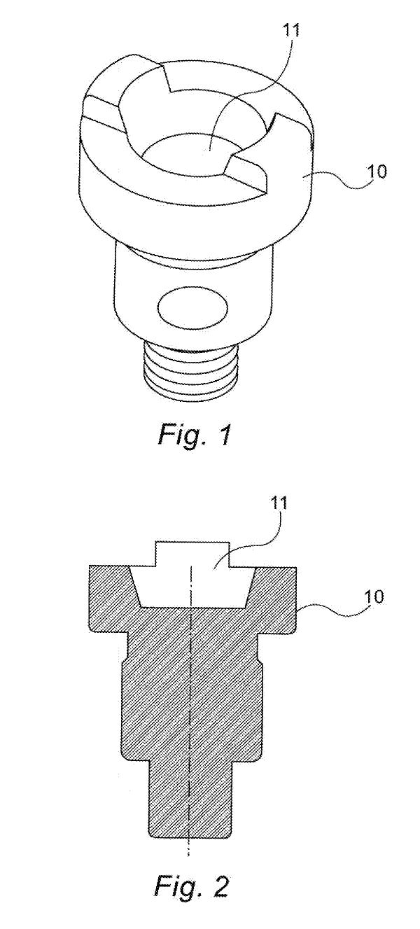

Reference is first made to FIGS. 1 to 3 which show a shape transfer cap used to determine intraorally the positioning and orientation of a dental implant fixed in a jawbone. For that purpose, the shape transfer cap is inserted in a corresponding dental implant in the mouth of a patient.

FIG. 1 shows a schematic isometric view of an example of a non-engaging shape transfer cap 10 of the type described in the present disclosure, having a negative depression in its upper surface 11, so that its negative in the impression will have a positive protruding feature, making it more accurate to scan.

FIG. 2 shows a cross sectional drawing of the shape transfer cap 10 of FIG. 1, showing the negative depression 11 in the top surface.

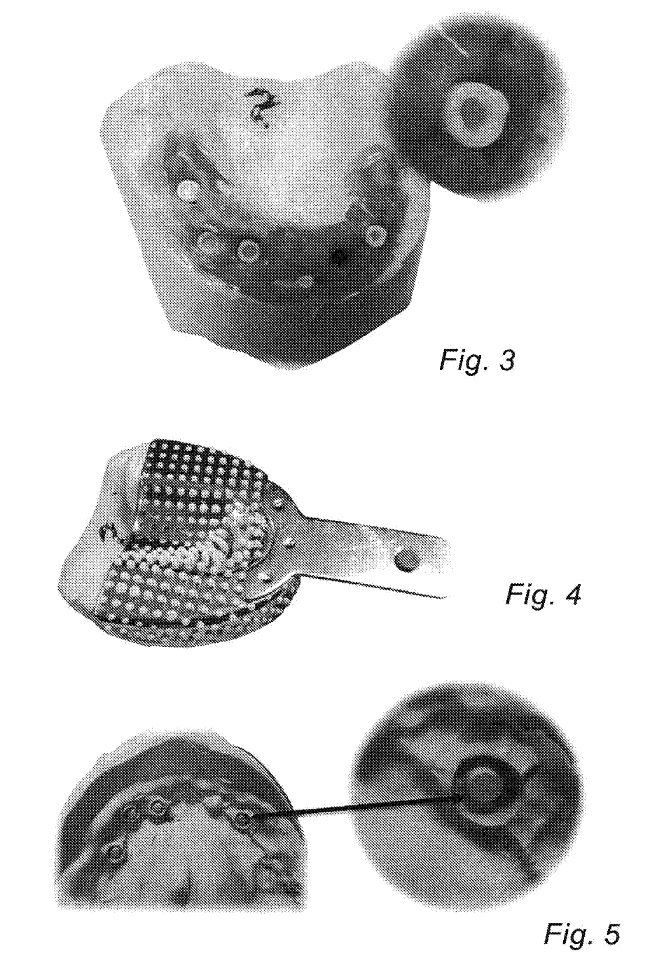

FIG. 3 shows an example of a patient's mouth with multiple shape transfer caps fitted.

A closed tray impression is then taken as illustrated schematically in FIGS. 4 and 5. FIG. 4 shows a closed tray impression. FIG. 5 is a photograph showing, on the left hand side of the drawing, the entire impression taken, while the right hand side of the drawing, there is shown a close up view of the impression of the shape transfer cap of the type described in FIG. 1, clearly showing the positive protruding shape created from the depressed geometry of the shape transfer cap.

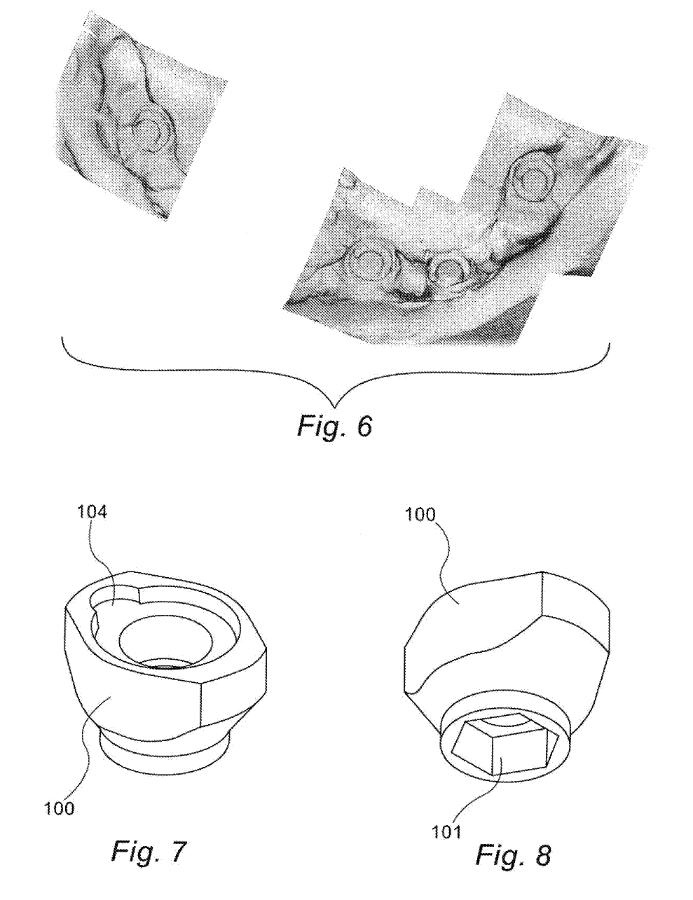

The impression of FIG. 5 may be directly scanned by an optical or other suitable scan system to generate the resulting digital image shown in FIG. 6, which is a representation of the digital output of the cloud of points from the digital scan, including the shape transfer cap. The scan result of the shape transfer cap may be compared to data obtained from the scan of a reference scan body from an electronic storage library, this scan body being the negative of the shape transfer cap. This comparison allows the exact determination of the position and the alignment of the dental implant, in particular also in relation to the gingiva, to adjacent teeth, to the jawbone region or to adjacent dental prostheses or dental implants. As a result, the designs of abutments and dental prostheses can be accurately and individually prepared from the results of the corresponding scan procedures. The shape transfer cap with the top region having a depression geometry, creates a positive geometry in the matching opposite impression, thus enabling a more accurate scanned result of the implant position than from the prior art use of scanning a gypsum model.

FIGS. 7 to 16 now illustrate various details of shape transfer caps and their location, in order to illustrate further its novelty and usefulness.

FIG. 7 is an isometric view of the top of an engaging shape transfer cap 100 having an engaging feature 104 whose orientation will be defined in FIG. 8;

FIG. 8 is an isometric view of the bottom of the shape transfer cap 100 of FIG. 7, showing a directionally selective body implant interface 101 in the base, which defines the orientation of the engaging feature 104 in the top surface of the transfer cap.

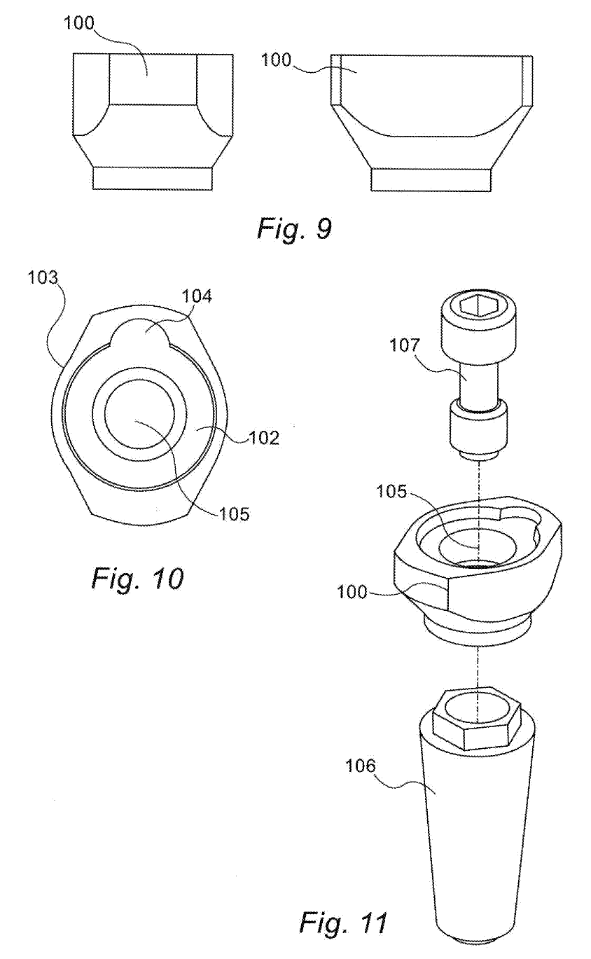

FIG. 9 shows front and side views of the shape transfer cap 100 of FIGS. 7-8;

FIG. 10 is a top view of the shape transfer cap 100 of FIGS. 7-9, showing the position engaging feature 104 and the hole 105 for the locking screw 107 of the cap.

FIG. 11 is a schematic exploded view of the component elements of the system for relating the shape transfer cap of FIGS. 7-10 to the implant, showing the shape transfer cap 100, the hole 105 for the tightening screw 107, and the implant 106.

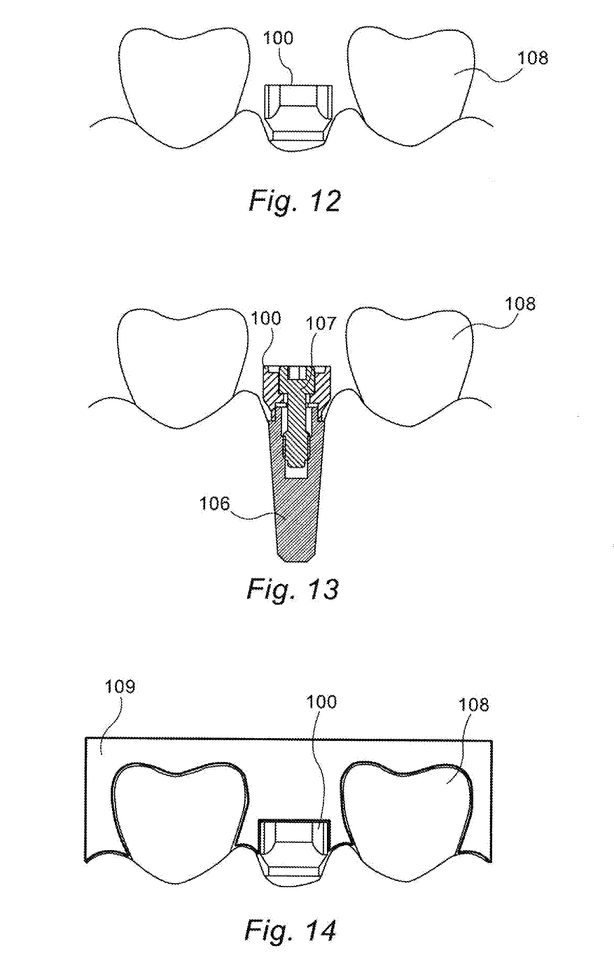

FIG. 12 now shows a representation of a shape transfer cap 100 of FIGS. 7-11, mounted on an implant (not visible) inside the patient's mouth between two teeth 108.

FIG. 13 shows a sectional view of the mouth of the patient of FIG. 12, showing the shape transfer cap 100 mounted on the implant 106 by means of the locking screw 107.

FIG. 14 shows schematically a closed tray impression taken on the section of the mouth shown in FIGS. 12 and 13, showing the impression material 109 defining in negative the patient's teeth 108 and the shape transfer cap 100.

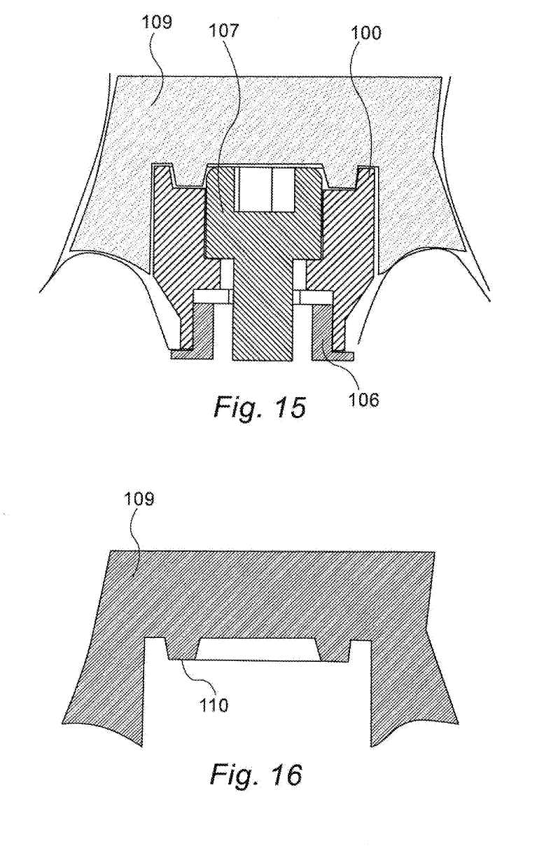

FIG. 15 shows a detailed cross-sectional view of the shape transfer cap during the impression taking procedure, showing the impression material 109, and the shape transfer cap 100 mounted on the implant 106 by means of the locking screw 107.

FIG. 16 shows a detailed cross-sectional view of the impression after extracting from the patient's mouth, showing the impression material 109, with the positive feature 110 generated from the corresponding negative feature of the shape transfer cap, this positive feature providing a more accurate scanning measurement than a negative hollow feature would have given.

In addition to the procedure described above, which facilitates the provision of accurate scanning measurements on the intra-oral cavity of a subject, the shape transfer cap described in this disclosure can also be used on an external dental model, for example a cast gypsum or a printed model, to determine the positioning and orientation of the analog in the model of a dental implant. For that purpose, the shape transfer cap is inserted in the corresponding dental model and then an impression is taken of the model including the shape transfer cap. This impression is then scanned to determine the accuracy of the location of the analog of the implant in the model, and therefore its suitability for use

According to this implementation of the methods and systems of the present disclosure, FIG. 3 would now be described as showing an example of a model of a patient's mouth with multiple shape transfer caps fitted into the implant positions of the model, and FIG. 5 then shows the impression of the model of FIG. 3, with the positive shape created from the depressed geometry of the shape transfer cap of FIG. 1.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. A system for determining the pose of a dental implant in a subject's oral cavity or on a model of a subject's oral cavity, said system comprising:
an imaging system comprising a camera system for three dimensional scanning of said oral cavity;
a scan body mounted on said dental implant, said scan body having a known spatial relation to said dental implant; and
an image processing system using images obtained from said camera system to determine the pose of said scan body,
wherein said scan body has a surface having a predetermined pattern, such that said image processing system can use images generated by said camera system of said predetermined pattern to extract the pose of said scan body.

2. A system according to claim 1 wherein said predetermined pattern includes the dimensions of the pattern or of its features.

3. A system according to claim 1, wherein said predetermined pattern is formed by features on the surface of said scan body.

4. A system according to claim 1, wherein said predetermined pattern comprises regions of different reflectivity on said surface of said scan body, and said camera system utilizes non-patterned illumination of said oral cavity.

5. A system according to claim 1, wherein said scan body is internally illuminated, and said features are transparent regions formed in a known pattern on the surface of said scan body.

6. A system according to claim 1, wherein said scan body has a surface pattern formed by at least one of engraving, marking or color.

7. A system according to claim 1 wherein said scan body is coated with or comprises a luminescent material.

8. A system according to claim 7 wherein said luminescent material is a photo-luminescent, fluorescent, or phosphorescent material.

9. A system according to claim 1, wherein said scan body further comprises a coded inscription that defines the dental implant to which it is attached.

10. A system according to claim 1, wherein said imaging system comprises at least one light source emitting non-patterned illumination.

11. A system according to claim 1, wherein said imaging system and said at least one light source are incorporated within a tray housing adapted to cover a dental arch of the subject.

12. A system according to claim 1, wherein said predetermined patterns are regions of different reflectivity on said surface of said scan body, and said camera system utilizes patterned illumination of said oral cavity.

13. A system according to claim 2, wherein said predetermined pattern is formed by features on the surface of said scan body.

14. A system according to claim 2, wherein said predetermined pattern comprises regions of different reflectivity on said surface of said scan body, and said camera system utilizes non-patterned illumination of said oral cavity.

15. A system according to claim 3, wherein said predetermined pattern comprises regions of different reflectivity on said surface of said scan body, and said camera system utilizes non-patterned illumination of said oral cavity.

16. A system according to claim 13, wherein said predetermined pattern comprises regions of different reflectivity on said surface of said scan body, and said camera system utilizes non-patterned illumination of said oral cavity.

17. A system according to claim 2, wherein said scan body is internally illuminated, and said features are transparent regions formed in a known pattern on the surface of said scan body.

18. A system according to claim 3, wherein said scan body is internally illuminated, and said features are transparent regions formed in a known pattern on the surface of said scan body.

19. A system according to claim 4, wherein said scan body is internally illuminated, and said features are transparent regions formed in a known pattern on the surface of said scan body.

20. A system according to claim 13, wherein said scan body is internally illuminated, and said features are transparent regions formed in a known pattern on the surface of said scan body.
